(19) United States
(12) Patent Application Publication
(10) Pub. No.: US 2026/0163961 A1
(43) Pub. Date: Jun. 11, 2026

(54) DATA SERVER WITH TRANSIT CONTAINERS FOR RESOURCE MOVEMENTS

(71) Applicant: Stripe, Inc., South San Francisco, CA (US)

(72) Inventors: Rishabh Jain, San Francisco, CA (US); David Ebrahim Yves Hatanian, San Carlos, CA (US); David Blinn, Briarcliff Manor, NY (US); Marvin Theimer, Seattle, WA (US)

(21) Appl. No.: 18/972,122

(22) Filed: Dec. 6, 2024

(51) Int. Cl. H04L 67/60; H04L 67/565

(52) U.S. Cl. CPC H04L 67/60; H04L 67/565

(57) ABSTRACT

A server may include a plurality of services, where in response to receiving a first API call, a service generates a transit container in memory that is associated with a transit group ID. In response to receiving a second API call with the transit group ID, the service moves the resource to the transit container. When the resource is deemed to be properly received, the state of the transit container is set to a resource held state. The first service is configured to access the resource of the transit container in the resource held state in response to one or more additional API calls that comprise the transit group ID. The first service releases the transit container for garbage collection when a condition of the transit container is satisfied.

### BACKGROUND

Data processing systems may comprise one or more computing devices that are connected over a wired and/or wireless communication medium. The medium may include any combination of wired transmission channels (e.g., fiber optic or traditional wire cables) and wireless channels (e.g., electromagnetic transmissions over frequency). This wired or wireless medium, the communication protocols used by the various computing devices, and intermediate devices between endpoints, may be referred to as a computer network. A data processing systems may act as a server which determines, retains, and transmits data electronically over the computer network to a client. A server may have a variety of real-world applications which may interact with other servers, or serve as an endpoint that interacts with human users. These applications are numerous in type and scope, and may include operations related to controlling machinery, transportation, detecting weather, telecommunications, cellular networks, maintaining records, artificial intelligence, facilitating transactions, and more.

Data processing systems may be connected over the computer network for transmitting and sharing information. Each data processing system may perform one or more dedicated services. Computing devices connected to a computer network may include mobile devices, machinery, industrial equipment, household equipment, medical equipment, home computers, web servers, file servers, and more. A computer network may include network-specific devices such as routers, switches, firewalls, and more.

Data processing systems may be connected to a computer network, and interact with one or more clients to support movement of physical resources (e.g., oil, coal, gasoline, grain, metal, lumber, etc.) or digital resources (e.g., credits, funds, etc.) from a source to a destination. The source and/or destination may be associated with same client or different clients. Data processing systems may facilitate numerous complex movements of resources for different clients in real-time (e.g., with minimal delay as the request is received from the client). In some cases, multiple resource movements may be grouped together due to a common purpose or scenario, further complicating the operation. It is desirable to support these resource movements with an efficient use of compute resources while ensuring correctness of these resource movements, being extensible, and being flexible in supporting a variety of different use cases by different potential clients.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 illustrates an example of a server computing system with a transit container feature, in accordance with an embodiment.

FIG. 2 shows an example of a transit container, in accordance with an embodiment.

FIG. 3 illustrates an example resource movement scenario with multiple sub-movements, in accordance with an embodiment.

FIG. 4 illustrates an example resource movement scenario with multiple sub-movements, in accordance with an embodiment.

FIG. 5 illustrates an example resource movement scenario with multiple sub-movements, in accordance with an embodiment.

FIG. 6 illustrates an example mapping of a user facing container and a transit container, in accordance with an embodiment.

FIG. 7 shows a flow diagram of a method for facilitating resource movements with a transit container, in accordance with an embodiment.

FIG. 8 is one embodiment of a computer system that may be used to support the systems and operations described, in accordance with an embodiment.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “determining”, “storing”, “detecting”, “applying”, “transmitting”, “moving”, “transitioning”, “configuring”, “transmitting”, “releasing”, “transitioning”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Operations said to be performed automatically may refer to operations being performed based on logic or an algorithm executed by a computing device, without human input at the time of the operation or decision.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

As described, movement of resources may be complex when there are multiple requests to move resources, and each request may invoke multiple movements across different sources and different destinations at different times. A computer data server may need to compose multiple single-leg resource movement instructions to model a desired behavior. While existing systems can achieve this using non-standardized intermediate containers, the resources in these containers tend to be fungible and not protected for an intended use. For example, asynchronous resource flows, such as revocations and refunds, can claim a resource from the intermediate containers used by complex resource flow scenarios, but because these intermediate containers do not treat the resources as non-fungible, the complexity of the different resource movements among many different requests may lead to intermingling of resources. Further, such systems may lack an efficient mechanism to reclaim memory used by these intermediate containers. Further, such systems may lack a well-defined state-based container to store resources, and well defined API calls that interact with these states to ensure correct flow of resources to or from the containers.

Aspects described may be performed by a distributed computing platform that comprises a plurality of services (e.g., microservices), each being independently runnable, independently buildable, and independently deployable, thereby providing extensibility and flexibility in supporting resource movements. Additional application-level or user-facing logic may be built into secondary services while a dedicated service manages a state-based transit container, as disclosed in the present disclosure.

Aspects described comprise a computer data server comprising services (and teams dedicated to building these services) that support simple and reliable earmarked resources for dedicated use within compound resource flow scenarios. A state-based transit container has states that supports calls from other services (e.g., products) of the computer data server. These calls are made to perform a resource movement that specifies the source or destination in any resource movement instruction, and are linked together using a transit group ID that the transit container is associated with. The transit group ID is used as access control to the transit container. Use of such a transit container, with a predefined set of API calls that limit flows of resources into and out of the transit container, provides built-in auditability that ensures that complex, multi-source, multi-destination flows of resources can be reliably delivered to the intended destinations without those resources being inadvertently being diverted or intermingled with other resources.

Aspects of the present disclosure may mitigate these issues by segregating earmarked resources in between individual resource flow operations and enforcing that only the intended operations can access those resources. Aspects of the disclosed computer data server may track and record every single resource flow that operates on the reserved resources, and ensure that all resources that are reserved in a transit container are eventually fully disbursed out to destinations such as other containers internal to the system, or external containers (e.g., an external container managed by a client device or database). Services within the computer data server can operate on the resources with reduced risk that the resources may be accidentally taken by another service, resulting in misuse of resources or balances of the resource inadvertently going negative.

In one aspect, a server computing system, includes a plurality of services, where a first service of the plurality of services is configured to perform operations including: in response to receiving a first API call, generating a transit container in memory that is associated with a transit group ID. In response to receiving a second API call with the transit group ID to move a resource into the transit container, the first service moves the resource to the transit container with a state of the transit container being an inbound pending held state. The first service then transitions the state of the transit container to a resource held state, in response to the resource being deemed to be received. The first service is configured to access the resource of the transit container in the resource held state in response to one or more additional API calls that comprise the transit group ID, and release the transit container for garbage collection in response to when a condition of the transit container is satisfied.

In an embodiment, the first service is further to: in response to receiving a third API call includes the transit group ID when the transit container has the resource held state, move an amount of the resource from the resource held state of the transit container and into a destination specified by the third API call. In an embodiment, the second API call moves the resource into the transit container from a resource state of the transit container. In an embodiment, in response to receiving the third API call when the transit container is in an inbound pending state or the inbound pending held state, the first service rejects the third API call.

In an embodiment, one of the plurality of services receives an external request from an external client over a computer network to move the resource to one or more destinations, and the first API call is transmitted to the first service in response to the external request.

In an embodiment, in response to receiving a third API call with the transit group ID from one of the plurality of services, the first service moves a portion of the resource from the transit container under the inbound pending held state to the transit container under the resource held state. In response to receiving a fourth API call with the transit group ID from one of the plurality of services, the first service moves a first specified portion of the resource from the transit container under the resource held state to a specified second container. In response to receiving a fifth API call with the transit group ID from one of the plurality of services, the first services moves a second specified portion of the resource to a specified third container. In such a manner, the transit container along with the transit group ID and the API calls may support a desired set of related movements of a resource.

In an embodiment, the service may further generate, with one of the plurality of services, a user facing container, map an inbound pending state of the user facing container to aggregated resources associated with inbound pending state, and transmit, to another service or to a client, the inbound pending state of the user facing container.

In an embodiment, in response to receiving a third API call from one of the plurality of services to move additional resources to the transit container, the first service moves the additional resources to the transit container with the state of the transit container being the resource held state. In response to receiving a fourth API call from one of the plurality of services, the first service transfers the resource of the transit container with the state of the transit container being the resource held state to a final one of the one or more destinations.

Transit containers also enable the overall system to capture a history of resource movements, which may satisfy regulations that complex resource movements are sufficiently locked down and cannot be used for purposes that go against required regulatory restrictions. More generally, these transit containers may support contractual or purely operational constraints associated with a movement of resources. Although the services still manage the orchestration of compound and complex resource flows, the state-based structure of transit containers and enforcement of particular workflows, as they are implemented and enforced through structured API calls, provide guardrails against intermingling, and a trail that enables services to determine whether compound resource flows have successfully cleared all resources to their intended destinations, in addition to other advantages described in other sections.

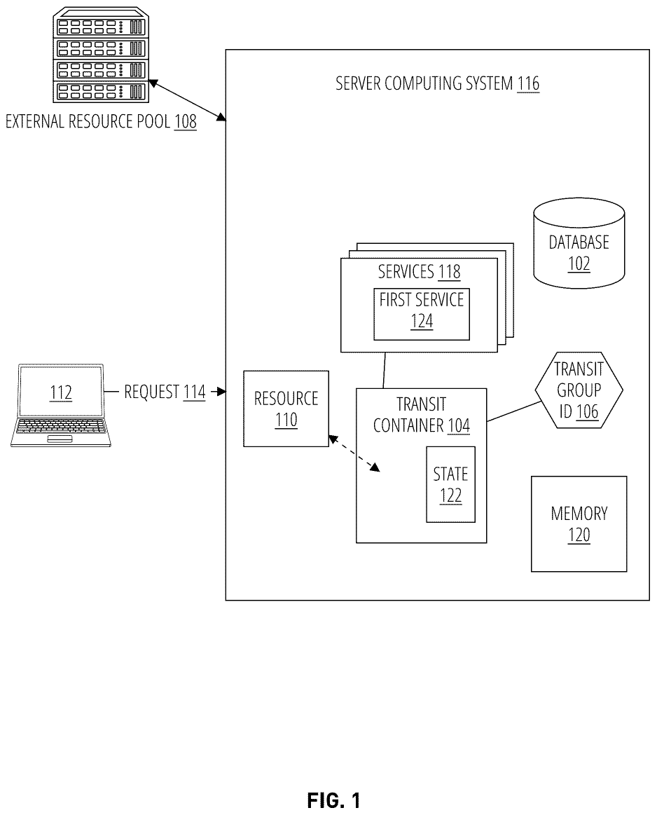

FIG. 1 illustrates an example of a server computing system with a transit container feature, in accordance with an embodiment. Server computing system 116 may comprise a plurality of services 118. Each of the plurality of services 118 may be independently buildable, runnable, and deployable. Each may comprise a dedicated set of compute resources (e.g., memory 120, processor resources, etc.). The services 118 may communicate with each other over a dedicated backplane (e.g., over a computer network) and may request operations of each other through well-defined API calls with agreed upon parameters and behavior. In an embodiment, the server computing system 116 may comprise a cluster, e.g., a group of interconnected computers or servers that work together as a single system.

Generally, one or more services 118 of the server computing system 116 may work together to provide a desired and encapsulated functionality to a client 112, and this functionality may be referred to as a product. In an example, server computing system 116 creates a transit container 104 on a per product, per client (e.g., a manufacturer, a warehouse, a merchant, a shipper, etc.), and product use case. This is done either when the client enables the product (e.g., through a network-based request 114), or when the client uses a transit container for the first time (e.g., also through the network-based request 114).

A first service 124 of the plurality of services 118 is configured to perform operations related to transit container 104. For example, another one of the services 118 may transmit a first API call to the first service 124. This first API call may be a request to generate a new transit container 104. In response to receiving the first API call, the first service 124 generates transit container 104 in memory 120 that is associated with a transit group ID 106. Memory 120 may represent short-term memory (e.g., random access memory), long-term memory (e.g., disk memory, solid state long-term memory, etc.), or a combination thereof. For example, transit container 104 may be stored in a database (e.g., database 102 or a different database), or in other long-term memory.

Generally, transit containers such as transit container 104 may be a subtype of non-transit containers. Each transit container 104 may act as source and/or destination of different resource flows. Each transit container may provide per-compound-resource movement clearing abilities. First service 124 limits access to transit container 104 by enforcing state-based rules and based on transit group ID 106. An API call to move a resource 110 into, within, or out of the transit container 104 must include the correct transit group ID 106 that the transit container 104 was created with.

Each transit container 104 provides a single request-based non-fungibility and debit-safety from unrelated resource flows and even instances of the same resource flow. Transit containers are generally created in the process of initiating a resource movement. Transit containers hold a balance or amount of a resource 110, and are always clearing: when all the resource movements touching a transit container 104 are complete, the transit container 104 must have a balance of zero. To achieve this, first service 124 performs a per-compound-resource movement tracking of inflows and outflows to a transit container 104, to provide clearing abilities. This allows the other services 118 to detect problematic compound resource flows. For example, other services 118 may perform asynchronous scanning of uncleared containers and, when found, generate an alert to handle the uncleared containers.

For example, after the transit container 104 is generated, first service 124 may receive a second API call with the transit group ID 106, requesting to move a resource 110 into the transit container. In response, the first service 124 moves the resource 110 to the transit container with a state of the transit container being an inbound pending held state. The inbound pending held and resource held states can be referred to as sub-containers or buckets inside the transit container. At any time, the transit container may contain some resources either one or both of those held states.

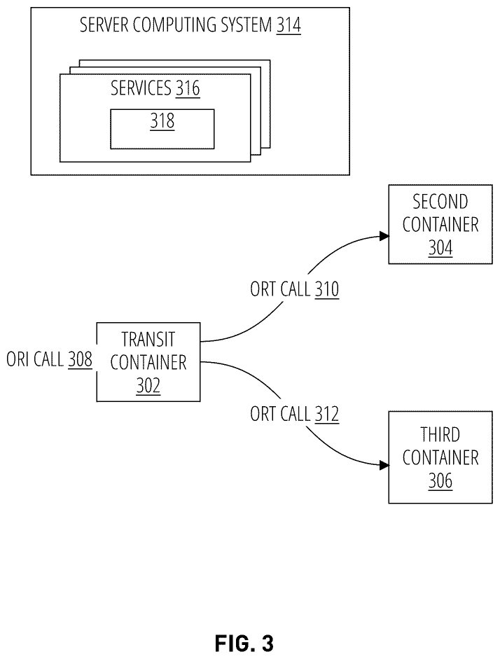

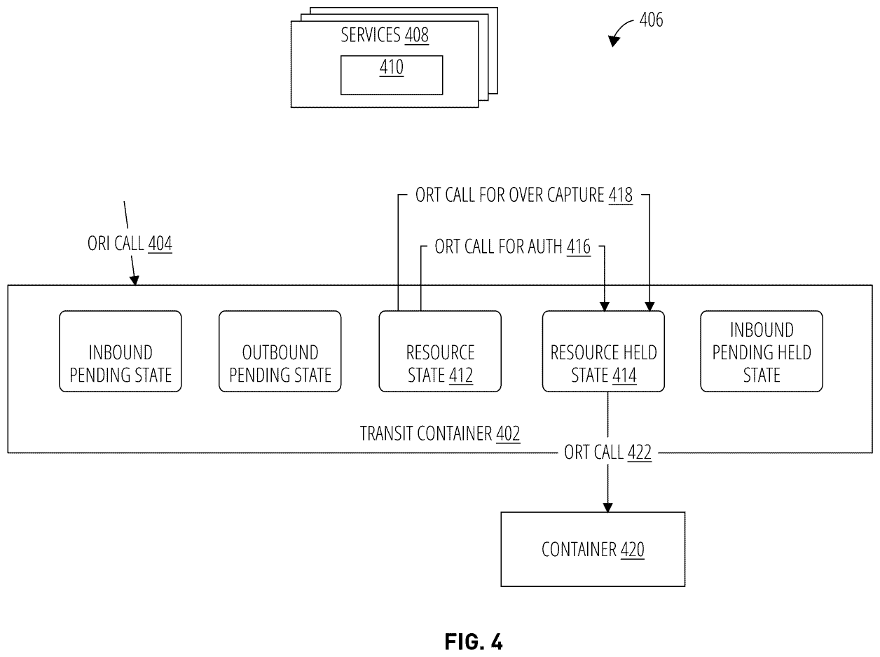

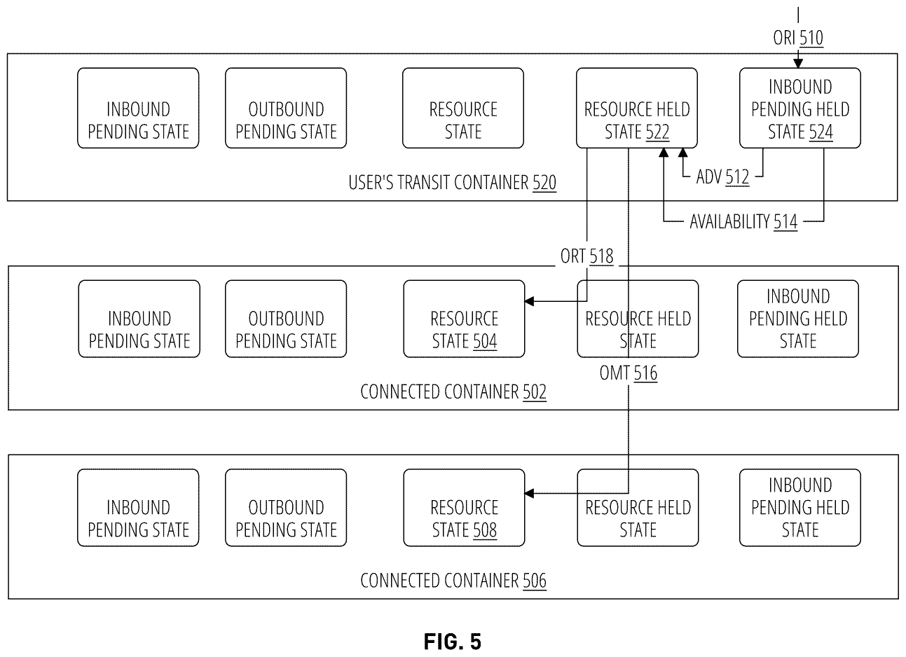

The first service 124 may transition the state 122 of the transit container 104 to a resource held state, in response to the resource being deemed to be available for additional movement by the first service 124. For example, if the resource 110 is a physical asset, this may be deemed available when the resource 110 is physically in possession or deposited in a physical location. The inbound pending held state may correspond to a request where those resources are in transit into the container, but not yet available (e.g., cargo in transit to a temporary holding location or money scheduled to arrive at an intermediary bank account). If the resource 110 is a digital resource (e.g., a fund, credit, etc.), then this resource may be deemed available for additional movement when the resource is transferred from an external resource pool 108 or from another digital container (such as another transit container, or a non-transit container) within the server computing system 116. The first service 124 is configured to access the resource 110 of the transit container which are held in the resource held state, when the first service receives one or more additional API calls, so long as these one or more additional API calls comprise the matching transit group ID 106. By doing so, other services can link up different inflows or outflows of resource 110, to serve a compound resource flow. Examples of such compound resource flows are described further, such as with respect to FIG. 3, FIG. 4 and FIG. 5. Some or all of resource 110 may initially be moved in from an external resource pool 108, or moved into the external resource pool 108 at the end of the group of movements, or both.

First service 124 uses the transit group ID 106 as an access control mechanism to the transit container 104 and resource 110 stored to the transit container 104, thereby preventing unauthorized or accidental movement of the resource 110 by other services 118. First service 124 rejects or drops API calls to move resources into or out of a transit container 104, when the correct transit group ID 106 is not included in the call.

First service 124 may release the transit container 104 for garbage collection in response to when the transit container 104 satisfies a condition. For example, if one or more API calls move all of the resource 110 out of transit container 104, then first service 124 may release transit container for garbage collection. In an embodiment, the condition is satisfied when a specified purpose of the transit container is met. This condition may be generated and stored in memory when the transit container is created. This purpose may be specified as an enumerated value by the calling service that creates the transit container. This mechanism provides flexibility for different use cases of the transit container, and is extensible in that additional use cases may be added on a per-product basis. In some aspects, one of the services 118 that may have access to the transit container 104 transmit a message to first service 124 to indicate that the condition is satisfied. Once discarded, a dedicated garbage collection service may allocate that memory previously occupied by the transit container 104 to a usable memory pool for future use by the services 218. In such a manner, the transit container 104 persists until it is no longer needed and additional calls need not be wasted to clear them or reallocate the memory for reuse.

Each flow of resources in or out of each transit container 104 is logged to database 102 and remains stored in memory 120 even after the transit container 104 is discarded, thereby preserving an accurate record of each resource inflow and outflow.

Various example call flows and resource movements are provided in the present disclosure. New services may be built to create new products that have built in logic to perform the described API calls to suit different clients and different scenarios. Transit container creation can be performed fast and may be archived once the product expects it will not have to handle new resource flows for a given client.

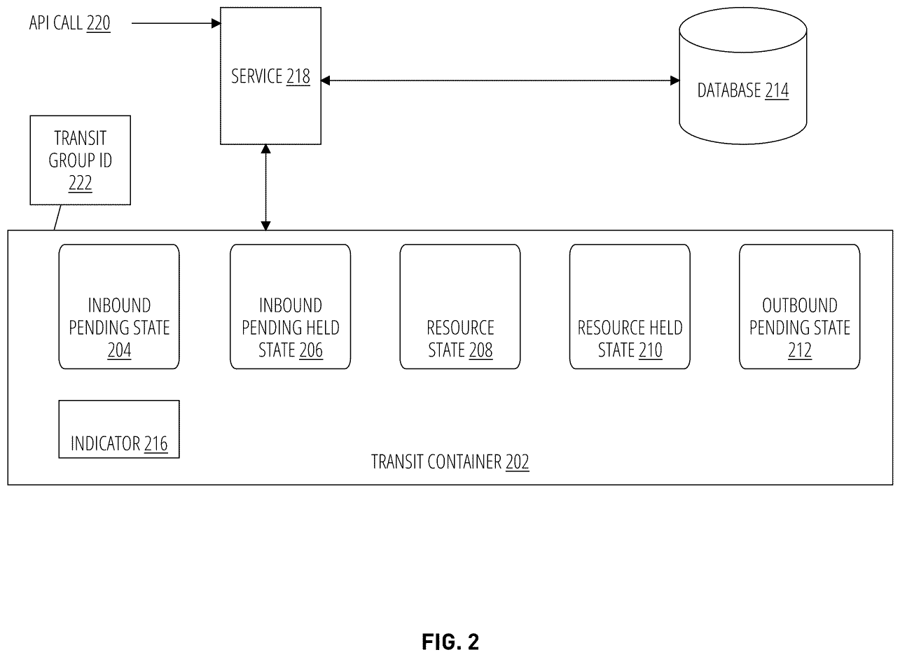

FIG. 2 shows an example of a transit container, in accordance with an aspect. Transit container 202 is an example of a transit container described in other sections, such as with respect to the other figures.

The transit container 202 may comprise different states that help to facilitate movements of resources to suit a variety of scenarios that involve related sub-movements. The transit container 202 may comprise different states such as an inbound pending state 204, inbound pending held state 206, resource state 208, resource held state 210, and outbound pending state 212. Some of these states such as the inbound pending held state 206, resource held state 210, and resource state 208 may be associated with its own store for resources within transit container 202.

Each time a resource is stored to or moved out of the transit container 202 for a specified state (including in-between states of the transit container), service 218 may store a corresponding entry in database 214, which may comprise the source or destination of the movement, or both, depending on availability. The source or destination of the entry may include the state of the container as well as a container identifier (e.g., a name). In an embodiment, when the resource movement is complete and amount of resource within the container is zero, the data corresponding data in the database 214 is marked as garbage collected. In such a case, historical movements on the transit container are freed up within database 214, but, in some embodiments, may be stored in as backups in long term memory storage and/or on an analytics platform.

Service 218 may be a dedicated service that handles requests to move resources into or out of transit container 202, and may interact with other services of a data server computing system, as described in other section. Service 218 may receive one or more API calls such as API call 220 which request to move a resource into or out of the transit container 202. As described, service 218 creates transit container 202 in response to an API call 220 that may specify that the request to generate a new container is to be a transit container, as opposed to a non-transit container. The transit container 202 is created with an associated transit group ID 222, which other services much use to successfully access the transit container 202. The transit container 202 may comprise an indicator 216 which indicates that this container is a transit container and carries with it the expectation that the container has each of the shown states and requires the associated transit group ID 222 for access.

An API call such as API call 220 may move a resource that is stored to the transit container 202 in one of the states to a different state in the same transit container 202 or to a different container. Generally, service 218 may comprise well defined API endpoints for accessing the transit container 202, so long as those API calls carry the transit group ID 222 that corresponds to the transit container 202.

Table I below describes properties for each state in further detail. These properties for each state are discussed in terms of fungibility vs non-fungibility, resources at-rest vs being in-transit, and how the transit container state maps to a user facing container state.

Fungibility refers to resources that are in fungible sub-balances which can be moved out of the transit container by any service regardless of which service moved the resource into the container, whereas non-fungible sub-balances ensure strict attribution and inflows/outflows are tracked per transaction and/or per transit group. For example, the calling service must use the transit group ID 222 to move resources into or out of the transit container 202, thereby acting as a proxy that the calling service is moving the resource on a per-transaction level. A fungible resource is an asset or good that can be readily exchanged for another of the same kind, meaning they are essentially identical and interchangeable, while a non-fungible resource is unique and cannot be replaced with another identical item; each unit has distinct characteristics making it different from others in the same category. Examples of a fungible resource may be a unit of energy (e.g., electricity, wattage, etc.), communication bandwidth (e.g., bytes per second, etc.), currency, a unit of gasoline, a cup of grains, etc. Examples of non-fungible resources are, for example, artwork, sports memorabilia, etc. In some examples, it is beneficial, even if the underlying resource is fungible, to treat it as non-fungible on a per transaction level. This is the case when servicing multiple requests where some of these requests may require multiple sub-data movements, so that resources on the transaction-level are not intermingled and so that each sub-data movement for the larger transaction is allocated a correct portion of the overall resource. In the context of the transit container, the resource is fungible if any service can claim those resources (e.g., without a transit group ID), and non-fungible if only services carrying the right transit group id can claim the resource. Among those services with the right transit group ID, the resources in the transit container are fungible, but through the overall system, those services without the right transit group ID will not be able to access the resource, thereby making the resource fungible based on the transit group ID.

For example, if the system is used to move X units of gravel from source A to destination B, but we know that Y units of gravel tend to be lost in transit, we can initiate a transaction-level move of X units to the transit container 202, and then another service can make a subsequent API call (with the right transit group ID) to service 218 to move Y units of gravel from source C to the transit container 202. Another service can make the final API call (also with the right transit group ID) to move X gravel, which has Y+loss added to it, to destination B. Even though gravel here is a fungible resource, each of those calls to move gravel into or out of transit container 202 require the transit group ID 222, thus making the gravel unique and non-fungible with respect to the transaction-level purpose of moving X units from source A to destination B.

Resources at-rest indicates that backing resource is in-hand and available, and inbound pending or outbound pending indicates the resource is inflight. A service may not assume that the resource is freely available for use (e.g., taking or distribution). For example, the system may initially receive the request to move X units of gravel from source A to destination B, but this X units may still be stored in its original location and is therefore in-transit. When the gravel is loaded in a container, then it may be considered at-rest because it is available and in-hand.

User-Facing Balance Mapping refers to a mapping between a user facing container representing the total actual resources and the portions of resources that are deemed to be in-transit or pending, as held by the transit container. The user facing container may be accessible by clients of a system that wish to check on status of their resource movement, while transit container 202 may be an internal data structure or logical representation within the system, comprising the various states and safeguards (e.g., the transit group ID 222) to support sub-movements of resources as described.

TABLE I

| | | Inbound | | | |
|---|---|---|---|---|---|
| | Inbound | Pending | | | |
| | Pending | Held | Resource | Resource | Outbound |
| Core Properties | State | State | State | Held State | Pending State |
| Fungible or | Fungible | Non-Fungible | Fungible | Non-Fungible | Non-Fungible |
| Non-Fungible | | | | | |
| Resources | In-Transit | In-Transit | At-Rest | At-Rest | In-Transit |
| At-Rest or | | | | | |
| In-Transit | | | | | |
| User-Facing | Inbound | Inbound | Resource | Outbound | Outbound |
| Balance | Pending | Pending | State | Pending | Pending |
| Mapping | State | State | | State | State |

As described, services may use transit container 202 for multiple movements or sub-movements of resources. These movements are tied together by the transit group ID 222. Each API call to service 218 to access the transit container 202 may comprise this transit group ID 222, thereby serving as access control based on the inter-relationship between the sub-movements. This mechanism also treats the otherwise fungible resource as non-fungible with respect to that transit group ID 222, which prevents intermingling of those resources with other of the same resource.

For example, if a resource movement is initiated that calls upon moving X gallons of oil to a final destination, but a portion Y of that amount is to be deposited at an intermediate destination, a first call may be made to service 218 to move X gallons into transit container 202. Service 218 may move the X gallons of oil into transit container 202 under the inbound pending state 204, and then into inbound pending held state 206 while the X gallons are in transit. At this point, another service may call service 218 to move Y gallons to the intermediate destination using the correct transit group ID 222 in the API call 220. Service 218 may reject any API call 220 that does not specify the correct transit group ID 222.

The transit container 202 may comprise enumerated states that may represent the state of the resource as it is deemed to be held by transit container 202. For example, if a resource is held in transit container 202 while the transit container 202 is in inbound pending state 204, this indicates that the resource is on its way to transit container 202, but not yet in-hand and ready to redistribute. A resource that is stored to transit container 202 in the inbound pending state 204 is fully fungible to operations such as bulk advances or delays. For example, another service may call upon the API 220 to perform a bulk advance of the specified resource or to delay the availability of this resource until a specified time.

During the inbound pending held state 206, services may use the resource storage as a proxy for pending resources that are not to be touched by other services, and while the transit container 202 is in this state, resources held in resource storage are protected from being bulk-advanced. In other words, while in inbound pending held state 206, a service is blocked from calling a bulk allocation of all resources stored to transit container 202.

In an example, transit container 202 is used to facilitate a digital transaction (e.g., payment for goods or services). Another service may initiate a payment through API call 220, and place a resource (e.g., funds in this case) in the transit container 202. This other service may anticipate that the digital transaction is going to be a multi-movement transaction, and therefore called for the creation of the transit container 202. The service may receive the transit group ID 222 and share this on a transaction level with other services involved in this transaction. Once the funds are stored to the transit container 202 in the inbound pending held state 206, the service 218 blocks bulk transfers of this resource, enabling other services to perform sub-movements of this resource so long as they make the API call 220 with the corresponding transit group ID. In such a manner, different transaction scenarios involving multiple parties and/or multiple resource movements such as those described with respect to FIG. 4 and FIG. 5 may be supported.

During the resource state 208, the resource storage holds resources that are backed by actual resources that are available for immediate use. For example, in the case of a gasoline, while the transit container 202 is in resource state 208, and database 214 holds a value of 12, this may indicate that 12 units (e.g., gallons, barrels, etc.) are available for immediate use and are stored in a corresponding physical storage. In another example, in the case of a computer-network based transaction, this may indicate that funds are placed in a temporary container and are available for immediate use by another service.

During the resource held state 210, similar to the inbound pending state 204, this resource held state 210 allows users to set aside resources for future use. Services may not aggregate on their allocated portion. For example, issuing a resource to be held will set aside that resource so that enough resources are available for a given request.

The outbound pending state 212 tracks resources that have been committed for outbound movements but the system is still performing the external leg to move that resource to the destination (e.g., a physical movement of a physical good, or a confirmation of a transfer of funds to a client account). In this state, service 218 blocks other services from taking the stored resources but may cancel operations within a specified window—resources are movement-level non-fungible because the only service access to this state is the ability to cancel an individual resource movement. In an example, the system will move the state of the transit container 202 to outbound pending state 212, when a call to complete a resource movement is received. Additional API calls 220 may be performed to move the resource from transit container 202 to an external container (e.g., to a client-managed database or account). For example, in the case of payments, the system may receive from a client, an event notification that the resource movement has been accepted, and in response, dedicated services will perform the API calls 220 to move the resource to the external container (e.g., a client account).

API call 220 may comprise a plurality of different defined and agreed upon API calls with agreed upon input and return parameters and agreed upon rules and behavior. A first API call (e.g., a transit container creation request) may specify to create a transit container 202. In response, service 218 may generate the transit container 202 and return a transit group ID 222 for accessing the transit container 202. Generating the transit container 202 may comprise instantiating an object and loading a representative data structure of the transit container 202 into memory, including all relevant fields such as, for example, the current state, Transit group ID 222, an indicator 216 defining it as being transit capable, etc.

In an embodiment, API call 220 may be referred to as an originated resource in (ORI) API call. This API call may specify a source of the resource to be stored to the transit container 202, and an amount of that resource. When the service 218 receives this ORI call with the specified Transit group ID 222, the service 218 will set the transit container 202 state to inbound pending held state 206 while the resource is in transit to the transit container 202. The service 218 will move this resource to the transit container 202 in the inbound pending held state 206. The source may include the source from which the resource is being sent from (e.g., a transit or non-transit container, an external device, etc.). Once the system receives the resource (e.g., a digital confirmation is received by the source that the resource now belongs to the system), the service 218 sets state of the transit container 202 to resource held state 210.

In an embodiment, an API call 220 may be referred to as an originated resource out (ORO) API call. When the service 218 receives this API call with the Transit group ID 222, then the service 218 may take the resource from resource held state 210. The service 218 moves the taken resource to a resource pool which may be allows those resources to be held by other containers (e.g., other transit or non-transit containers) or otherwise moved by other services or taken externally (e.g., by a client). In an embodiment, when this API call is directed at resource held state 210, the service 218 transitions the transit container 202 from resource held state 210 to outbound pending state 212 once the resource is released to the resource pool. In an embodiment, the service returns the resources to the status from which it was sourced if this API call fails. For example, if an ORO call tries to release an amount of the resource that exceeds that which is in resource held state 210, the resources are returned to resource held state 210, thereby protecting the transit container 202 and stored resource from going negative.

In an embodiment, an API call 220 may be referred to as an originated resource transfer (ORT) API call 224. When service 218 receives this ORT API call, it will transfer the resource between a stated source and a stated destination that are specified in the ORT API call. If the ORT API call is received with a Transit group ID 222, then the stated source and stated destination will be accessed from the resource held state 210. Otherwise, the service 218 will access the resources from the resource state 208. In an embodiment, the ORT call may specify that delayed availability of the resource is to be applied on the destination side. In this case, the service 218 may transition the state of the transit container 202 to inbound pending held state 206 and then to resource held state 210, based on the stated delay.

By structuring the API calls to require a Transit group ID 222 to access resources in transit states (e.g., resource held state 210 and inbound pending held state 206), and by enforcing state-based movement rules for each API call, the service 218 may ensure proper flow of the resources between storages, prevent potential negative resource balance, and importantly, maintain grouping of sub-movements of resources within an overarching larger movement of the resource, per the transit group ID 222.

FIG. 3 illustrates an example resource movement scenario with multiple sub-movements, in accordance with an embodiment. Transit containers act as virtual locations that the system leans on to connect interrelated resource movements together.

Generally, a server computing system 314 may correspond to that which is described in other sections. Server computing system 314 may comprise a plurality of services 316, some of which may handle transit or non-transit containers, others may interact with clients, others may perform strictly application-based logic for different scenarios, etc. In this scenario, a first service 318 may receive a first API call (e.g., a transit container creation API call) from one of the other services 316. In response, first service 318 may generate a transit container 302 in memory that is associated with a transit group ID.

The first service 318 may receive a second API call (e.g., an ORI call 308) with the transit group ID to move a resource into the transit container 302. In response, the first service 318 may move the resource to the transit container 302 with a state of the transit container being an inbound pending held state. Under this state, the stored resource becomes non-fungible for the purpose of movement of the resource under the specified transit group ID, so that the resource balance under this transit group ID is maintained separate from the overall resource pool that may be otherwise available to other services 316. The first service 318 transitions the state of the transit container to a resource held state, in response to the resource being deemed to be available for additional movement by the first service. At this point, the resource becomes fungible again, but additional services 316 may request the first service 318 for access to the resource stored to transit container 302 in a non-fungible manner, by using API calls with the transit group ID.

First service 318 may receive a third API call (ORT call 310) that requests a portion of the resources stored to transit container 302 be transferred to a specified destination (second container 304). This ORT call 310 is called with the requisite transit group ID. In response, first service 318 moves the specified portion of the resource from the transit container (e.g., under the inbound pending held state or resource held state of transit container 302) to the destination transit container.

Additionally, first service 318 may receive a fourth API call (ORT call 312) that requests a remaining portion of the resources stored to transit container 302, with the requisite transit group ID included in the call, to be moved to a second destination (e.g., third container 306). In response, first service 318 may move the specified remaining portion from the transit container (e.g., under the inbound pending held state or resource held state of transit container 302) to this third container.

In an example, call flow shown in FIG. 3 represents an inline resource movement which protects the resources stored to transit container 302 by limiting access based on transit group ID, until each OMT call is received. For example, assuming that X coal is placed on a truck, the first destination of the coal may be sent to a destination associated with second container 304, and the second and final destination of the coal may be associated with third container 306. Similarly, in the case of an inline fee during a funds-based transaction, the payment may be split out the inline fee and send it to the third container 306 while moving the remaining funds to second container 304.

More generally, based on the hidden state-based logic of each transit container, there is no material change in the storage of transaction, resource controls, resource flows, or regulatory tagging, so that the transit container capabilities are added to the system with minimal impact to other operations and services of the system, thereby reducing impact to processing overhead and additional software builds and roll outs.

FIG. 4 illustrates an example resource movement scenario with multiple sub-movements, in accordance with an embodiment.

Generally, a server computing system 406 may correspond to that which is described in other sections. Server computing system 406 may comprise a plurality of services 408, some of which may handle transit or non-transit containers, others may interact with clients, others may perform strictly application-based logic for different scenarios, etc. In this scenario, a first service 410 may receive a first API call (e.g., a transit container creation API call) from one of the other services 408. In response, first service 410 may generate a transit container 402 in memory that is associated with a transit group ID.

The first service 410 may receive a second API call (e.g., an ORI call 404) with the transit group ID to move a resource into the transit container 402. In response, the first service 410 may move the resource to the transit container 402 with a state of the transit container being an inbound pending held state. Under this state, the stored resource becomes non-fungible for the purpose of movement of the resource under the specified transit group ID, so that the resource balance under this transit group ID is maintained separate from the overall resource pool that may be otherwise available to other services 408. The first service 410 transitions the state of the transit container to a resource held state, in response to the resource being deemed to be available for additional movement by the first service. At this point, the resource becomes fungible again, but additional services 408 may request the first service 410 for access to the resource stored to transit container 402 in a non-fungible manner, by using API calls with the transit group ID. For example, the first service 410 may receive a third API call (e.g., ORT call 416) from one of the services 408 which transfers a resource amount (e.g., X funds) from the resource state 412 to resource held state 414 of transit container 402. Although not used in this example, the inbound pending state of each transit container may be set when resources are en route into the transit container (e.g., from an external source or other container) and the outbound pending state may be set when resources are en route out of the transit container (e.g., to an external source or other container).

Assuming that resource 110 comprises additional resources from previous moves, the first service 410 may receive a fourth API call (e.g., OMT call 416) from one of the plurality of services 408 to move Y additional resources from the resource state 412 to resource held state 414.

In response to receiving a fifth API call (e.g., ORT call 418) from one of the plurality of services 408, first service 410 may transfer the resource (e.g., X+Y amounts of funds) from the resource held state 414 of the transit container 402 to container 420. Container 420 may be an internal transit or non-transit container. In an embodiment, container 420 may be an external client account hosted by a client device over a computer network.

Dedicated ones of the services 408 make the ORT call 416 and ORT call 418 as part of the same overarching transaction, and therefore, would use the same transit group ID in these calls to access the same transit container 402. In an example, FIG. 4 may illustrate the scenario of a reserve/allocate behavior such as authorization and capture on a credit card. ORT call 416 may represent an initial issuing authorization of a fund movement for which first service 410 moves an initial authorized amount of X funds from resource state 412 to resource held state 414. ORT call 418 moves resources into the resource held state 414 to add the Y amount of funds, in the case of over capture.

For example, X funds are initially authorized to pay for a meal, but X+Y amount is actually needed to successfully pay for the meal (costing X) and a tip (costing Y). Services 408 may interact with external client devices and detect the need to account for this over capture, and make ORT call 418 in the amount of Y to account for what otherwise would be a shortfall when performing the ORT call 422. Container 420 may, in this example, represent a client account of the payee (e.g., a restaurant, coffee shop, etc.). Other examples such as, for example, allocation of wireless bandwidth, movement of units of energy, or moving physical commodities (e.g., grains, fuel, gravel, etc.) may also be modeled with this or a different call flow.

FIG. 5 illustrates an example resource movement scenario with multiple sub-movements, in accordance with an embodiment.

As described with respect to FIG. 4 and other figures, access and movement of resources to or from a transit container is controlled by a service, and may be called upon by other services of a server computing system. Assuming that a user's transit container 520 has already been generated and resources are currently stored to user's transit container 520 using an ORI 510, placing these resources in the inbound pending held state 524. These resources are now non-fungible, and to access them, the requisite transit group ID is needed to be called.

Another service may transmit API call to cause and advance of a portion of the resource stored to inbound pending held state 524 to move to resource held state 522 where it may now be moved to another container. The advance call 512 may be made by a service to move a portion Y of the in-transit resources not yet in-hand to the resource held state 522. That same service, or a different service, may make a call (ORT 518) to move the Y resources from the resource held state 522 to a different connected container 502, thereby providing an advance of the resources. The Y resources may be moved to the resource state 504 of connected container 502.

Further, when the resource from the ORI 510 is deemed to be received (e.g., in-hand), then a service may automatically perform operation 514 and move the balance of the resources to the resource held state 522. For example, if ORI 510 initially moved X amount into the inbound pending held state 524, and adv 512 moved Y amount to the resource held state 522, then operation 514 moves X-Y into the resource held state 522. A service may then make the OMT 516 call to move those remaining resources (e.g., X-Y amount) to another connected container 506. This remaining resources may be moved to the resource state 508 of the connected container 506. Although not used in this example, the inbound pending state of each transit container may be set when resources are en route into the transit container (e.g., from an external source or other container) and the outbound pending state may be set when resources are en route out of the transit container (e.g., to an external source or other container).

In an embodiment, the shown call flow in FIG. 5 can support movement of physical resource or virtual resources. For example, the ORI may be called upon when a movement of coal is initiated, and that amount of coal may be moved to inbound pending held state 510. The system may perform the advance 512 and ORT 518 to signal the advance movement of the coal to a first destination, and then when the coal is in-hand (e.g., on the truck), make the OMT 516 call and drop the coal two destinations, corresponding to connected container 502 and connected container 506. In an embodiment, the shown call flow in FIG. 5 may represent a separate charge and transfer scenario where goods or services may be purchased from a single vendor at the front end, but then those proceeds are to be moved to different vendors or accounts on the back end, and at different times or with different priority levels. The movement of the resources from the inbound pending held state to the resource held state 522 may be limited by the responsible service, to only advance-based API call with the correct transit group ID, thereby preventing use of in-transit resources other than for an advance, and preventing inadvertent access by other services that are not involved in the overall resource movement.

It should be understood that any number of different calls may be performed to control flows of resources between containers and/or between containers and external account. The application-level logic may be performed by one or more dedicated services that may interface with client devices externally and with each other, as described. Generally, the structure of the user's transit container 520 and the defined API calls support a variety of call flow scenarios that link up sub-resource movements for a related purpose.

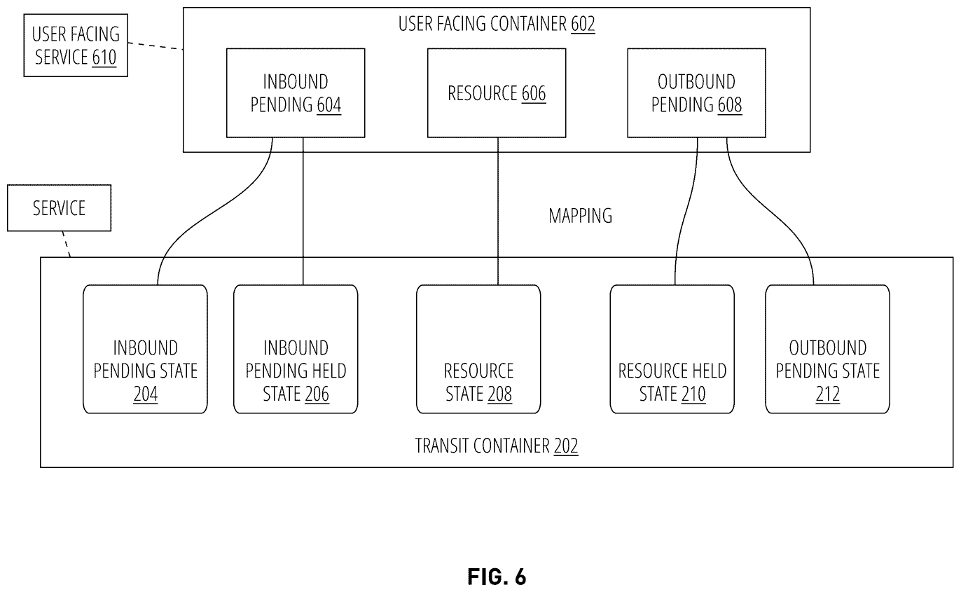

FIG. 6 illustrates an example mapping of a user facing container and a transit container, in accordance with an embodiment.

The user facing container 602 may be exposed to an external user (e.g., a client, a service, an external device, etc.) and the mapping between the user facing container 602 and the transit container 202 hides the complexity of transit-based operations, thereby simplifying and improving experience to a user. For example, a user may transmit a request to a server computing system as described in other sections, and one or more services of the server computing system may return a request to provide the resources currently stored in the user facing container 602 under inbound pending 604, resource 606, and/or outbound pending 608.

In an embodiment, when the data processing system receives a request that is associated with a resource movement, the data processing system may generate a user facing container 602 and associated service. Similarly, the data processing system may generate transit container 202. Transit container 202 may support non-transit as well as transit-based capabilities. For example, depending in response to the request being associated with multiple sub-resource movements, the transit container 202 may be generated (e.g., instantiated) with an indication that resource held state 210 and inbound pending held state 206 are supported by the transit container 202. In response to the request being only a single resource movement, the transit container 202 is generated without the resource held state 210 and inbound pending held state 206. In this manner, the system may need not create or manage additional transit containers 202 to support multiple sub-resource movements, since the transit capabilities are embedded in transit container 202.

In an embodiment, the data processing system comprises a dedicated service for user facing container 602. This dedicated service may be accessible to other services through an API such as, for example, a Remote Procedure Call (RPC) API. In an example, an RPC call may be made from an external service to the user facing service 610 to obtain status (e.g., a quantity) of the resource 606. In an embodiment, user facing service 610 may respond to this by returning one or more resource quantities that are mapped to transit container 202.

For example, if an external service requests the resource quantity associated with inbound pending 604, the user facing service 610 may aggregate all inbound pending state 204 and inbound pending held state 206 of the transit container 202 and return this aggregate as inbound pending 604 to the external service.

In an embodiment, if an external service requests the resource quantity of resource 606, user facing service 610 may directly map the resource 606 of the user facing container 602 to the resource state 208 of the transit container 202, and return the resource quantity associated with resource state 208.

In an embodiment, if an external service requests the resource quantity of outbound pending 608, the user facing service 610 may aggregate resource held state 210 and outbound pending state 212 and return this aggregated quantity to the requesting service as outbound pending 608.

Because all of these states inbound pending state 204, inbound pending held state 206, resource state 208, resource held state 210, and outbound pending state 212 are located within the same transit container 202, despite the aggregation, user facing container 602 reads would not suffer from a balance dip or double counting, or zero counting, when moving resources between statuses within the same transit container 202, as it otherwise would when moving resources between separate non-transit and transit containers.

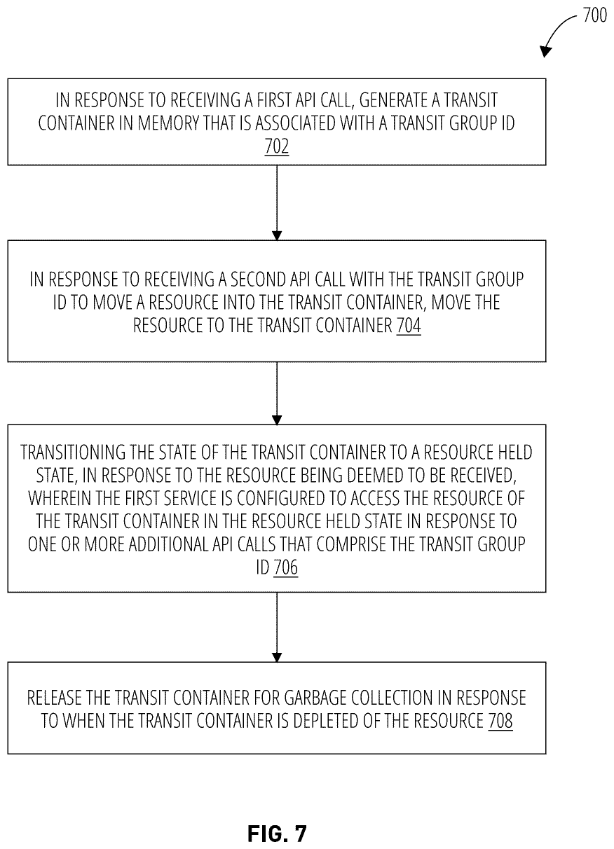

FIG. 7 shows a flow diagram of a method for facilitating resource movements with a transit container, in accordance with an embodiment.

The method 700 may be performed by processing logic that may comprise hardware (circuitry, dedicated logic, etc.), software (such as is run on a general purpose computer system or a dedicated machine), firmware, or a combination. Processing logic may comprise a plurality of processors operating in a distributed computing architecture (e.g., a plurality of services that may be distributed over different servers on a computer network). Each service may be a self-contained buildable and deployable set of machine-executable instructions with dedicated computer resources such as processors, processor bandwidth, network transceiver resources, computer memory, etc. Method 700 may be performed by a server computing system or service thereof, as described in other sections.

At block 702, in response to receiving a first API call, processing logic generates a transit container in memory that is associated with a transit group ID. In an example, processing logic may instantiate an object where the object becomes the transit container. Processing logic may generate a unique transit group ID which is associated with this transit container, and return it to the caller of the first API call. In an example, processing logic may comprise a separate API call that returns the transit group ID based on a specified input name or credentials or both. The first API call may be referred to as a transit container creation API call. In an example, the first API call may be an ORI or ORT call to a transit group ID or transit container that does not yet exist. In response, processing logic may create the transit container, and associate it with the specified transit group ID, or provide a new transit group ID to the caller. Processing logic may also perform the ORI or ORT once created.

At block 704, in response to receiving a second API call with the transit group ID to move a resource into the transit container, processing logic moves the resource to the transit container. In an embodiment, this move is performed with a state of the transit container being an inbound pending held state (e.g., a resource is moved from an external pool, into the transit container under the inbound pending held state, and then the resource is transitioned to resource held). In another embodiment, this resource move is performed directly from the external resource pool to the resource held state of the transit container. Each of the states of the transit container may represent its own sub-container that can hold an amount of the resource, for example, the inbound pending held state and the resource held state may each be a separate container for the resource within the transit container. In an embodiment, the second API call may be an ORI call or an ORT call. In an embodiment, the second API call comprises an advance call to advance a portion of the resource from a source to a destination. As described, when resources are stored to the transit container under the inbound pending held state, processing logic may block bulk advances (a request to advance the entire amount of the resource), but partial advances may be approved and performed.

At block 706, processing logic transitions the state of the transit container to a resource held state, in response to the resource being deemed to be received, wherein the first service is configured to access the resource of the transit container in the resource held state in response to one or more additional API calls that comprise the transit group ID. The resource may be deemed to be received by processing logic, based on one or more factors, for example, based on a time threshold, based on a digital confirmation message received over a computer network, based on another service providing the confirmation, or based on one or more sensors detecting that the resource is physically received or present in a designated location, or a combination thereof

At block 708, processing logic releases the transit container for garbage collection in response to when a condition of the transit container is satisfied. In an embodiment, the condition is satisfied when the transit container is depleted of the resource. In another embodiment, the condition comprises a specified purpose of the transit container, which may be generated and stored in memory when the transit container is created. The condition may be deemed to be satisfied when the purpose of the transit container is met (e.g., the resource has been successfully moved to the final destination, or the amount of the resource in the transit container is zero, or both).

The specified purpose may be expressed as a value or an enumerated value, by the calling service that creates the transit container. This provides flexibility for different use cases of the transit container, and is extensible in that additional use cases may be added on a per-product basis. Each calling service initiating the creation of the transit container is expected to know the purpose of each transit container, and may specify it dynamically at the time of creation. The calling service may be part of the product that uses the transit container to move the resource in accordance with a desired workflow.

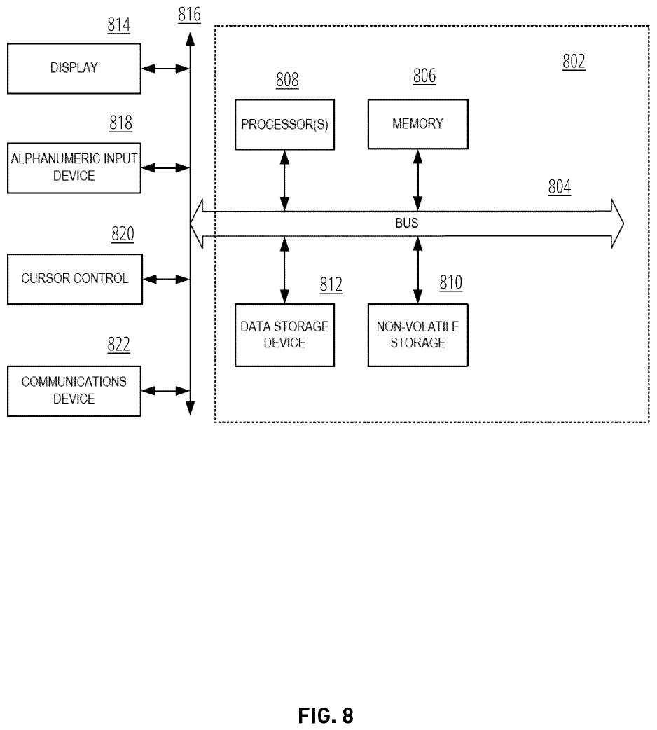

FIG. 8 is one embodiment of a computer system that may be used to support the systems and operations described, in accordance with an embodiment. For example, the computer system illustrated in FIG. 8 may be used by a forwarding server, a requesting server, a destination endpoint, etc. It will be apparent to those of ordinary skill in the art, however that other alternative systems of various system architectures may also be used.

The computer system 802 illustrated in FIG. 8 includes a bus or other internal communication means 804 for communicating information, and one or more processors 808 coupled to the bus 804 for processing information. The system further comprises a random access memory (RAM) or other volatile storage device 806 (referred to as memory), coupled to bus 804 for storing information and instructions to be executed by processor 808. Main memory 806 also may be used for storing temporary variables or other intermediate information during execution of instructions by processor 808. The system also comprises a read only memory (ROM), non-volatile storage, and/or static storage device 810 coupled to bus 804 for storing static information and instructions for processor 808, and a data storage device 812 such as a magnetic disk or optical disk and its corresponding disk drive. Data storage device 812 is coupled to bus 804 for storing information and instructions.

The system may further be coupled to a display device 814, such as a light emitting diode (LED) display or a liquid crystal display (LCD) coupled to bus 804 through bus 816 for displaying information to a computer user. An alphanumeric input device 818, including alphanumeric and other keys, may also be coupled to bus 804 through bus 816 for communicating information and command selections to processor 808. An additional user input device is cursor control device 820, such as a touchpad, mouse, a trackball, stylus, or cursor direction keys coupled to bus 804 through bus 816 for communicating direction information and command selections to processor 808, and for controlling cursor movement on display device 814.

Another device, which may optionally be coupled to computer system 802, is a communication device 822 for accessing other nodes of a distributed system via a network. The communication device 822 may include any of a number of commercially available networking peripheral devices such as those used for coupling to an Ethernet, token ring, Internet, or wide area network. The communication device 822 may further be a null-modem connection, or any other mechanism that provides connectivity between the computer system 802 and the outside world. Note that any or all of the components of this system illustrated in FIG. 8 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 806, mass storage device 812, or other storage medium locally or remotely accessible to processor 808.

It will be apparent to those of ordinary skill in the art that the system, method, and process described herein can be implemented as software stored in main memory 806 or read only memory and executed by processor 808. This control logic or software may also be resident on an article of manufacture comprising a computer readable medium having computer readable program code embodied therein and being readable by the mass storage device 812 and for causing the processor 808 to operate in accordance with the methods and teachings herein.

The embodiments discussed herein may also be embodied in a handheld or portable device containing a subset of the computer hardware components described above. For example, the handheld device may be configured to contain only the bus 804, the processor 808, and memory 806 and/or 812. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 808, a data storage device 812, a bus 804, and memory 806, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A server computing system, comprising a plurality of services, wherein a first service of the plurality of services is configured to perform operations comprising:
in response to receiving a first API call, generating a transit container in memory that is associated with a transit group ID;
in response to receiving a second API call associated with the transit group ID to move a resource into the transit container, moving the resource to the transit container;
in response to the resource being deemed to be received by the first service, transitioning the state of the transit container to a resource held state, wherein the first service is configured to access the resource of the transit container in the resource held state in response to one or more additional API calls that comprise the transit group ID; and
releasing the transit container for garbage collection in response to when a condition of the transit container is satisfied.

2. The server computing system of claim 1, further comprising: in response to receiving a third API call associated with the transit group ID when the transit container has the resource held state, moving an amount of the resource from the resource held state of the transit container and into a destination specified by the third API call.

3. The server computing system of claim 2, further comprising: in response to receiving the third API call when the transit container is in an inbound pending state or an inbound held state, rejecting the third API call.

4. The server computing system of claim 1, wherein the second API call moves the resource into the transit container from a resource state of the transit container.

5. The server computing system of claim 1, wherein one of the plurality of services receives an external request from an external client over a computer network to move the resource to one or more destinations, and the first API call is transmitted to the first service in response to the external request.

6. The server computing system of claim 5, further comprising: in response to receiving a third API call from one of the plurality of services to move additional resources to the transit container, moving, by the first service, the additional resources to the transit container with the state of the transit container being the resource held state.

7. The server computing system of claim 6, further comprising: in response to receiving a fourth API call from one of the plurality of services, transferring the resource of the transit container with the state of the transit container being the resource held state to a final one of the one or more destinations.

8. The server computing system of claim 1, further comprising:
in response to receiving a third API call with the transit group ID from one of the plurality of services, moving a portion of the resource from the transit container under an inbound pending held state to the transit container under the resource held state;
in response to receiving a fourth API call with the transit group ID from one of the plurality of services, moving a first specified portion of the resource from the transit container under the resource held state to a specified second container; and
in response to receiving a fifth API call with the transit group ID from one of the plurality of services, moving a second specified portion of the resource to a specified third container.

9. The server computing system of claim 1, further comprising:
generating, with one of the plurality of services, a user facing container;
mapping an inbound pending state of the user facing container to aggregated resources associated with inbound pending state; and
transmitting, to another service or to a client, the inbound pending state of the user facing container.

10. A method, performed by a first service of a plurality of services of a computing system, the method comprising:
in response to receiving a first API call, generating a transit container in memory that is associated with a transit group ID;
in response to receiving a second API call with the transit group ID to move a resource into the transit container, moving the resource to the transit container;
transitioning the state of the transit container to a resource held state, in response to the resource being deemed to be received by the first service, wherein the first service is configured to access the resource of the transit container in the resource held state in response to one or more additional API calls that comprise the transit group ID; and
releasing the transit container for garbage collection in response to when a condition of the transit container is satisfied.

11. The method of claim 10, further comprising: in response to receiving a third API call comprising the transit group ID when the transit container has the resource held state, moving an amount of the resource from the resource held state of the transit container and into a destination specified by the third API call.

12. The method of claim 11, wherein in response to receiving the third API call when the transit container is in an inbound pending state or the inbound pending held state, the first service rejects the third API call.

13. The method of claim 10, wherein the second API call moves the resource into the transit container from a resource state of the transit container.

14. The method of claim 10, wherein one of the plurality of services receives an external request from an external client over a computer network to move the resource to one or more destinations, and the first API call is transmitted to the first service in response to the external request.

15. The method of claim 14, further comprising: in response to receiving a third API call from one of the plurality of services to move additional resources to the transit container, moving, by the first service, the additional resources to the transit container with the state of the transit container being the resource held state.

16. A non-transitory computer readable storage medium storing instructions, which when executed by a first service of a plurality of services of a server computing system, causes the first service to perform operations comprising:
in response to receiving a first API call, generating a transit container in memory that is associated with a transit group ID;
in response to receiving a second API call with the transit group ID to move a resource into the transit container, moving the resource to the transit container;
transitioning the state of the transit container to a resource held state, in response to the resource being deemed to be received by the first service, wherein the first service is configured to access the resource of the transit container in the resource held state in response to one or more additional API calls that comprise the transit group ID; and
releasing the transit container for garbage collection in response to when a condition of the transit container is satisfied.

17. The non-transitory computer readable storage medium of claim 16, further comprising: in response to receiving a third API call comprising the transit group ID when the transit container has the resource held state, moving an amount of the resource from the resource held state of the transit container and into a destination specified by the third API call.

18. The non-transitory computer readable storage medium of claim 17, wherein in response to receiving the third API call when the transit container is in an inbound pending state or an inbound pending held state, the first service rejects the third API call.

19. The non-transitory computer readable storage medium of claim 16, wherein the second API call moves the resource into the transit container from a resource state of the transit container.

20. The non-transitory computer readable storage medium of claim 16, wherein one of the plurality of services receives an external request from an external client over a computer network to move the resource to one or more destinations, and the first API call is transmitted to the first service in response to the external request.
